(19) United States
(12) Patent Application Publication
(10) Pub. No.: US 2014/0013278 A1
(43) Pub. Date: Jan. 9, 2014

(54) METHOD FOR SETTING WALLPAPER AND DITIGAL MEDIA CONTROLLER

(71) Applicant: PEGATRON CORPORATION, Taipei City (TW)

(72) Inventors: Jih-Wei WU, Taipei City (TW); Po-Jen CHIU, Taipei City (TW)

(73) Assignee: PEGATRON CORPORATION, Taipei City (TW)

(21) Appl. No.: 13/846,122

(22) Filed: Mar. 18, 2013

(30) Foreign Application Priority Data
Jul. 6, 2012 (TW) 101124464

(51) Int. Cl. G06F 3/0482

(52) U.S. Cl. CPC G06F 3/0482
USPC 715/835

(57) ABSTRACT

A method for setting a wallpaper picture and a digital media controller. A first picture is retrieved from a destination folder of a digital media server according to a file source list. The first picture is set as the current wallpaper picture of the touch-sensitive display unit, wherein a display size of the first picture conforms to a desktop display rule of the touch-sensitive display unit.

### CROSS REFERENCE TO RELATED APPLICATIONS

This Non-provisional application claims priority under 35 U.S.C. §119(a) on Patent Application No(s). 101124464 filed in Taiwan, Republic of China on Jul. 6, 2012, the entire contents of which are hereby incorporated by reference.

### BACKGROUND

1. Technology Field

The disclosure relates to a method for setting wallpaper pictures and a digital media controller and, in particular, to a method that is capable of immediately downloading and automatically setting wallpaper pictures and a digital media controller therefor.

2. Related Art

With the rapid development of science and technology, the size of a mobile phone or a mobile device has become smaller. The storage capacity of a mobile phone or a mobile device has been also reduced accordingly. Generally speaking, the wallpaper of a mobile phone may change freely depending on user's preference. However, the precondition is that the picture used as the wallpaper must be stored in this mobile phone.

In other words, if the user of the mobile phone wants to use a picture not stored in the mobile phone as the wallpaper of the mobile phone, the user must download this picture to the mobile phone then can he or she use the picture as the wallpaper of the mobile phone. Moreover, the resolution or the size of the downloaded picture may be incompatible with the resolution of the display of the mobile phone, which results in that the picture needs to be cut before it can be used as the wallpaper since its resolution is too high or its size is too large. This reduces the convenience of the user significantly.

### SUMMARY

The disclosure provides a method for setting a wallpaper picture and a digital media controller, in which a complete picture provided by a digital media server can be used as the wallpaper picture immediately, thereby enhances the convenience of setting of the wallpaper picture significantly.

The disclosure provides a method for setting a wallpaper picture adapted for a digital media controller having a touch-sensitive display unit, the digital media controller having a file source list, the file source list providing a path of a destination folder of a digital media server. The method includes retrieving a first picture from the destination folder of the digital media server according to the file source list when a trigger event is detected, and using the first picture as a current wallpaper picture of the touch-sensitive display unit. A display size of the first picture conforms to a desktop display rule of the touch-sensitive display unit.

In one embodiment of the invention, the method for setting a wallpaper picture further includes displaying a first operation interface, and when a selecting operation corresponding to the first operation interface is detected, selecting the digital media server and the destination folder according to the selecting operation.

In one embodiment of the invention, the method for setting a wallpaper picture further includes retrieving a second picture from the destination folder of the digital media server after a default time, and setting the second picture as the current wallpaper picture of the touch-sensitive display unit. A display size of the second picture conforms to the desktop display rule of the touch-sensitive display unit.

In one embodiment of the invention, the method for setting a wallpaper picture further includes setting the first picture as the current wallpaper picture of the touch-sensitive display unit when a first input signal is detected. The first input signal is triggered by touching a first control area of the touch-sensitive display unit.

In one embodiment of the invention, the method for setting a wallpaper picture further includes retrieving a third picture from the destination folder of the digital media server according to the file source list when a second input signal is detected, and setting the third picture as the current wallpaper picture of the touch-sensitive display unit. The second input signal is triggered by touching a second control area of the touch-sensitive display unit.

In one embodiment of the invention, the method for setting a wallpaper picture further includes defining the first control area and the second control area of the touch-sensitive display unit.

In one embodiment of the invention, the method for setting a wallpaper picture further includes re-retrieving the first picture from the destination folder of the digital media server according to the file source list.

In one embodiment of the invention, the method for setting a wallpaper picture further includes executing an application process when a third input signal is detected. The third input signal is triggered by touching an application process shortcut on the touch-sensitive display unit.

The invention also provides a digital media controller, including a touch-sensitive display unit, an event-detecting unit, a picture-retrieving unit and a wallpaper picture-setting unit. The event-detecting unit is coupled with the touch-sensitive display unit for detecting a trigger event. The picture-retrieving unit is coupled with the event-detecting unit. The wallpaper picture-setting unit is coupled with the touch-sensitive display unit, the event-detecting unit and the picture-retrieving unit. When the event-detecting unit detects a trigger event, the picture-retrieving unit retrieves a first picture from a destination folder of a digital media server according to a file source list. The wallpaper picture-setting unit sets the first picture as a current wallpaper picture of the touch-sensitive display unit. A display size of the first picture conforms to a desktop display rule of the touch-sensitive display unit.

In one embodiment of the invention, the touch-sensitive display unit displays a first operation interface. When the event-detecting unit detects a selecting operation corresponding to the first operation interface, the picture-retrieving unit selects the digital media server and the destination folder according to the selecting operation.

In one embodiment of the invention, the picture-retrieving unit retrieves a second picture from the destination folder of the digital media server after a default time. The wallpaper picture-setting unit sets the second picture as the current wallpaper picture of the touch-sensitive display unit. A display size of the second picture conforms to the desktop display rule of the touch-sensitive display unit.

In one embodiment of the invention, when the event-detecting unit detects a first input signal, the wallpaper picture-setting unit sets the first picture as the current wallpaper picture of the touch-sensitive display unit. The first input signal is triggered by touching a first control area of the touch-sensitive display unit.

In one embodiment of the invention, when the event-detecting unit detects a second input signal, the picture-retrieving unit retrieves a third picture from the destination folder of the digital media server according to the file source list. The wallpaper picture-setting unit sets the third picture as the current wallpaper picture of the touch-sensitive display unit. The second input signal is triggered by touching a second control area of the touch-sensitive display unit.

In one embodiment of the invention, the digital media controller further includes a control region-defining unit coupled with the touch-sensitive display unit for defining the first control area and the second control area of the touch-sensitive display unit.

In one embodiment of the invention, the picture-retrieving unit re-retrieves the first picture from the destination folder of the digital media server according to the file source list.

In one embodiment of the invention, the digital media controller further includes an application process executing unit coupled with the event-detecting unit. When the event-detecting unit detects a third input signal, the application process executing unit executes an application process, and the third input signal is triggered by touching an application process shortcut on the touch-sensitive display unit.

Based on the above, the embodiments of the invention provide a method for setting a wallpaper picture and the digital media controller that can retrieve a picture according to preset rules, set the retrieved picture as the current wallpaper picture of the touch-sensitive display unit of the digital media controller immediately, and adjust the display size of the picture according to the desktop display rule of the touch-sensitive display unit of the digital media controller to display it at the desktop completely without distortion. Therefore, the convenience of setting the wallpaper picture of the electronic device is significantly enhanced.

The invention will become more fully understood from the detailed description and accompanying drawings, which are given for illustration only, and thus are not limitative of the present invention.

### BRIEF DESCRIPTION OF THE DRAWINGS

FIG. 1 is a schematic diagram showing a digital media controller and a digital media server according to an embodiment of the invention.

FIG. 2 is a schematic diagram of the user interface displayed by the touch-sensitive display unit according to an embodiment of the invention.

FIG. 3 is a schematic diagram showing the user interface displayed by the touch-sensitive display unit according to another embodiment of the invention.

FIG. 4 is a schematic flowchart showing the method for setting a wallpaper picture according to an embodiment of the invention.

### DETAILED DESCRIPTION

To allow an electronic device with a small storage capacity such as a mobile phone, to display immediately or to switch wallpapers, the embodiment of the invention provides a method for setting a wallpaper picture, which can retrieve a picture from a digital media server immediately when a trigger event (such as an instruction of a user to switch the wallpaper picture) is detected, and use that picture as the wallpaper picture. Moreover, the embodiment also adaptively adjust the display size of the picture used as the wallpaper picture according to the desktop display rule of the touch-sensitive display unit (for example, the resolution of the wallpaper picture or the display type of the wallpaper picture, the display type including displaying in full-screen, displaying in a set size, or displaying in the original size). In this way, a complete picture without being cut can be displayed as the wallpaper picture on the desktop of the touch-sensitive display unit immediately. Furthermore, the embodiment of the invention further discloses the digital media controller to implement the method for setting a wallpaper picture mentioned above. To make the invention be more comprehensive, an embodiment will be described below as an example of enabling the invention.

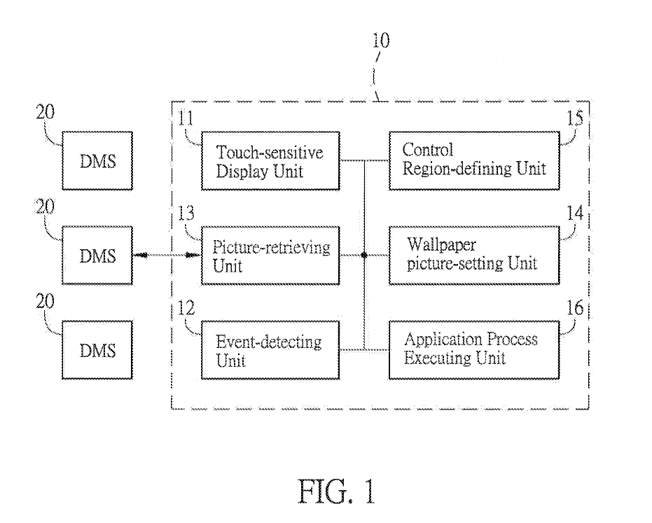

FIG. 1 is a schematic diagram showing a digital media controller and a digital media server according to an embodiment of the invention. Referring to FIG. 1, the digital media controller 10 includes a touch-sensitive display unit 11, an event-detecting unit 12, a picture-retrieving unit 13 and a wallpaper picture-setting unit 14. The digital media controller 10 may be implemented in various kinds of electronic devices, such as a mobile phone, a PDA (personal digital assistance), a smart phone, an electronic book, a game console or a tablet computer. Moreover, the digital media controller 10 may also be implemented in an electronic device similar to a desktop computer. The way of implementing the digital media controller 10 is not limited herein. It should be noted that in the exemplary embodiment, the digital media controller 10 may also include other elements or units, and the invention is not limited herein.

The touch-sensitive display unit 11 is used to be the input and output interface, and can display a wallpaper picture. In the present embodiment, the touch-sensitive display unit 11 may be a touch screen or a touch panel of, for example, the capacitive type, the voltage type, or the optical type. The event-detecting unit 12 is used to detect a trigger event or an input signal of the touch-sensitive display unit 11, such as detecting an input operation of the touch of the user's finger on the touch-sensitive display unit 11. In the present embodiment, the event-detecting unit 12 may be a touch screen controller, a processor, or a controller that has signal processing and analyzing capabilities. Moreover, the event detectable by the event-detecting unit 12 may also be the detection of a facial expression, a gesture, or a vocal instruction of the user. The type of the signal detectable by the event-detecting unit 12 of the invention is not limited herein.

The picture-retrieving unit 13 is used for retrieving a picture. For example, the picture-retrieving unit 13 may retrieve one or more pictures from the digital media server 20 via the Internet through a network interface card (not shown). The wallpaper picture-setting unit 14 is coupled to the touch-sensitive display unit 11, event-detecting unit 12 and the picture-retrieving unit 13 to set the wallpaper picture of the touch-sensitive display unit 11.

The digital media server 20 may be a DLNA (Digital Living Network Alliance) server or another server supporting peer-to-peer file transmissions. The invention is not limited herein. In the present embodiment, the digital media server 20 may store pictures of different sizes and different resolutions in one or more folders, respectively Each folder and the file path of each file stored in the folder may be recorded in one of more file source lists. With such arrangement, the picture source of the wallpaper picture may be changed according to the preference of the user anytime. However, the invention is not limited herein. In another embodiment of the invention, the user may select several folders in several digital media servers via the user interface shown on the touch-sensitive display unit 11, and set these folders as destination folders as well. With such arrangement, the pictures may be retrieved by switching between these destination folders according to the need of the user anytime.

More specifically, in the present embodiment, the digital media controller 10 may receive one or more file source lists from the selected digital media server 20. When the event-detecting unit 20 detects a trigger event (such as the instruction issued by the user to switch the wallpaper picture), the picture-retrieving unit 13 can download pictures from the destination folder of the digital media server 20 according to the one or more file source lists mentioned above, and the wallpaper picture-setting unit 14 sets the retrieved picture as the current wallpaper of the touch-sensitive display unit 11.

In the present embodiment, when the wallpaper picture-setting unit 14 sets the retrieved picture as the current wallpaper picture of the touch-sensitive display unit 11, the wallpaper picture-setting unit 14 may further adjust the display size of this picture adaptively to conform to the desktop display rules of the touch-sensitive display unit 11. The desktop display rules mentioned above may be, for example, the resolution of the wallpaper picture or the display type (including displaying in full-screen, displaying in a set size, or displaying in the original size) of the wallpaper picture.

For example, in the present embodiment, when a picture is selected to be displayed as the wallpaper picture, the wallpaper picture-setting unit 14 may first determine whether this picture is suitable to be displayed as the wallpaper picture of the touch-sensitive display unit 11 directly (for example, displaying the complete picture in full-screen, displaying the complete picture in a set size, or displaying the complete picture in the original size). If it is not suitable to be used as the wallpaper picture of the touch-sensitive display unit 11 directly (for example, the resolution of the picture is too low or too high), the wallpaper picture-setting unit 14 may adjust the display size of this picture according to the current screen resolution of the touch-sensitive display unit 11. For another example, in one embodiment, the wallpaper picture-setting unit 14 may compare the original size of the picture with the current screen resolution of the touch-sensitive display unit 11. If the original size of the picture exceeds the full-screen display scope corresponding to the current screen resolution, the wallpaper picture-setting unit 14 may reduce the resolution of the picture to reduce the display size of the whole picture without changing its overall scale so as to use the complete picture as the wallpaper picture and display it on the desktop. Furthermore, if the original size of the picture is too small, the wallpaper picture-setting unit 14 may adjust the display size of the picture in a similar way to conform to the desktop display rule of the touch-sensitive display unit 11. Therefore, the user does not need to trim the picture additionally, and the picture can be presented as the wallpaper picture completely.

Moreover, in another embodiment of the invention, the user can further select one or more folders of the digital media controller or the storage unit of the electronic device implementing the digital media controller as the destination folders mentioned above. Accordingly, the user can determine whether to retrieve the picture to be used as the wallpaper picture from the destination folder of a remote digital media server or from the destination folder of the storage unit of the local device by selecting manually or by setting the picture download rules. For example, the user can add file paths respectively corresponding to the pictures stored in the digital media controller 10 and the digital media server 20 in a file source list, so that the picture-retrieving unit 13 can retrieve the pictures based on the file source list. In other words, based on the above, the digital media controller 10 can retrieve the pictures stored in the digital media controller 10 itself as the wallpaper pictures of the touch-sensitive display unit 11 even under the condition that the digital media controller 10 is not connected with the Internet.

It is noteworthy that the trigger event mentioned in the embodiments of the invention may be generated actively according to a preset rule, or generated passively according to the wallpaper-switching instruction issued by the user. For example, every specific number of seconds (such as 10 seconds) or after a default time, the event-detecting unit 12 may notify the picture-retrieving unit 13 to send a request packet to the digital media server 20. The request packet carries information relevant to the to-be-retrieved picture (such as the name of the picture or the file path, etc.) so that the digital media server 20 can transmit the corresponding picture to the picture-retrieving unit 13 according to this request packet. With such arrangement, the picture-retrieving unit 13 can retrieve multiple pictures in the destination folders sequentially according to one or more file source lists retrieved from the digital media server 20, and set the downloaded pictures as the wallpaper pictures of the touch-sensitive display unit 11 sequentially.

Moreover, in another embodiment of the invention, the touch-sensitive display unit of the digital media controller (such as the touch-sensitive display unit 11) may further display a user interface for the user to issue the wallpaper-switching instruction. For example, when the event-detecting unit 12 receives the wallpaper-switching instruction issued by the user via the touch-sensitive display unit 11, it can retrieve corresponding pictures from the digital media server 20 according to this wallpaper-switching instruction.

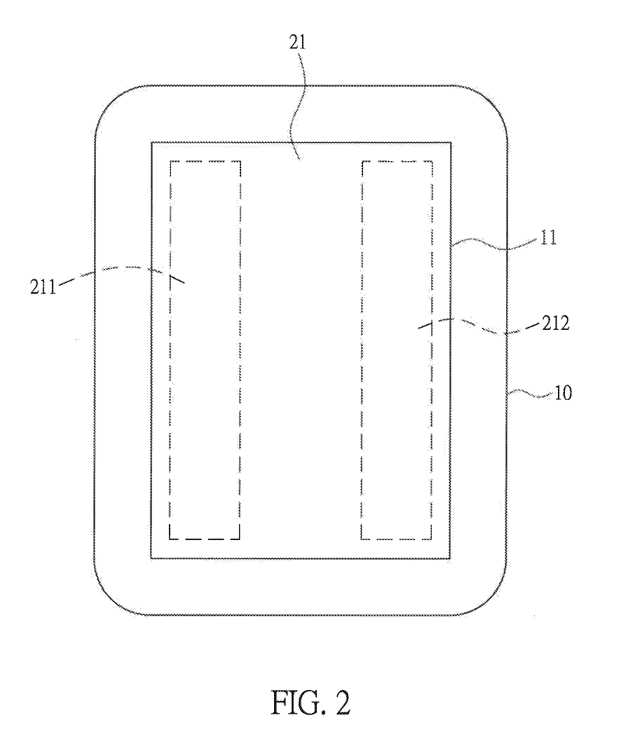

For example, FIG. 2 is a schematic diagram of the user interface displayed by the touch-sensitive display unit 11 according to an embodiment of the invention. Referring to FIG. 2, the touch-sensitive display unit 11 may display the user interface 21 while displaying one wallpaper picture, so that the user can send an input signal to the user interface 21 by touching or other input methods anytime while viewing the wallpaper picture to execute functions such as picture-switching. Particularly, in the present embodiment, the user interface 21 may be transparent to prevent it from covering the wallpaper picture or other items displayed by the touch-sensitive display unit 11.

Referring again to FIG. 1, to achieve the above-mentioned functions, in one embodiment of the invention, the digital media controller 10 may further include a control region-defining unit 15. The control region-defining unit 15 is coupled to the touch-sensitive display unit 11 to define a plurality of control regions of the touch-sensitive display unit 11.

More specifically, referring to FIG. 2 again, the control region-defining unit 15 divides the user interface 21 displayed by the touch-sensitive display unit 11 into a first control area 211 and a second control area 212. For example, the control region-defining unit 15 may divide the display screen area displayed by the touch-sensitive display unit 11 into left, middle and right portions of similar sizes, so that the first control area 211 and the second control area 212 may be located at the corresponding positions of the left and the right portions, respectively. Thereby, the first control area 211 and the second control area 212 can be managed suitably, and input signals corresponding to different areas may be generated separately when the touch operations at different areas are detected.

For example, when the coordinate corresponding to the touch operation of the user on the touch-sensitive display unit 11 is within the first control area 211, the touch-sensitive display unit 11 sends a first input signal to the event-detecting unit 12. When the event-detecting unit 12 detects this first input signal, it determines that the wants to execute the predetermined operation corresponding to the first control area 211.

In the present embodiment, the predetermined operation corresponding to the first control area 211 may be using the picture retrieved and set last time to be the current wallpaper picture of the touch-sensitive display unit 11 according to the file source list currently referring to. Moreover, the predetermined operation corresponding to the second control area 212 may be downloading another picture from the digital media server (such as the digital media server 20) according to the file source list currently referring to, and use the picture retrieved as the current wallpaper picture of the touch-sensitive display unit 11.

In more detail, when the event-detecting unit 12 detects the input signal corresponding to the first control area (such as the touch of the user), the picture-retrieving unit 13 may query the file source list currently referred to, to retrieve the file path of the wallpaper picture at the digital media server, which picture was used as the wallpaper picture before the setting of the current wallpaper picture, and download it from the digital media server according to this file path to use it as the current wallpaper picture of the touch-sensitive display unit 11.

Furthermore, in another embodiment of the invention, the picture used to be downloaded may be stored at the digital media controller 10 (such as in its memory) for a period of time to then determine whether to delete it or not. Accordingly, when it is needed to reload the last picture and display it as the wallpaper picture, the picture-retrieving unit 13 may read it according to the file name or the number of the last picture directly and set it as the current wallpaper picture of the touch-sensitive display unit 11 by the wallpaper picture-setting unit 14.

On the other hand, when the event-detecting unit 12 detects the input signal corresponding to the second control area 212 (such as the touch of the user), the picture-retrieving unit 13 may query the currently-referred-to file source list to retrieve the file path of the picture next to the current wallpaper picture at the digital media server (such as the digital media server 20) and download the picture from the digital media server according to this file path to use it as the current wallpaper picture of the touch-sensitive display unit 11. However, it should be noted that the predetermined operations corresponding to the first control area 211 and the second control area 212 respectively may have other variations. For example, when the user touches the second control area 212, the touch-sensitive display unit 11 may display a picture selecting window for the user to select the picture to be used as the wallpaper picture subsequently. In other words, the predetermined operations of the control areas of the invention mentioned above are not limited herein.

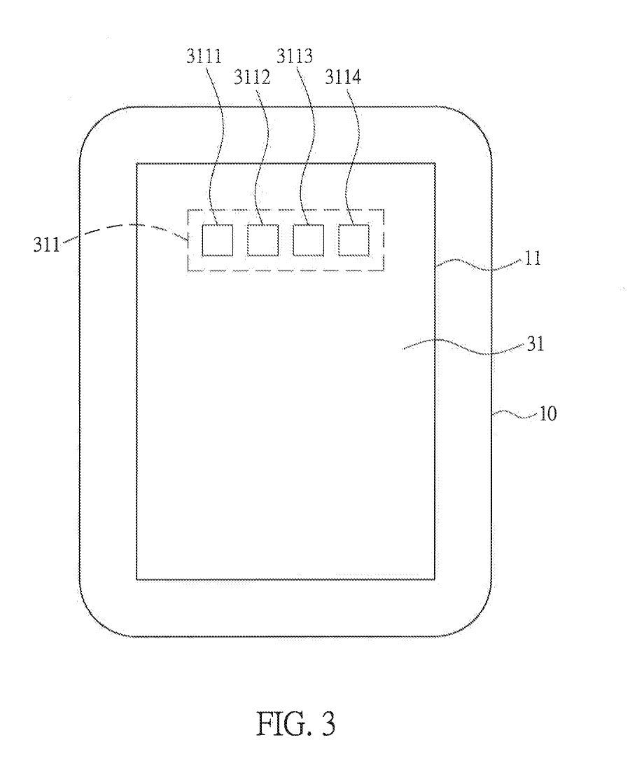

FIG. 3 is a schematic diagram showing the user interface displayed by the touch-sensitive display unit 11 according to another embodiment of the invention. Referring to FIG. 3, in the present embodiment, the user interface 31 is substantially similar to the user interface 21 shown in FIG. 2. The difference is that the user interface 31 may further include a third control area 311. The scope of the third control area 311 may also be set by the control region-defining unit 15. Particularly, the third control area 311 may have a plurality of application process shortcuts 3111˜3114 corresponding to application processes, respectively.

In the present embodiment, the digital media controller 10 may further include an application process executing unit 16. The application process executing unit 16 is coupled with the event-detecting unit 12 for executing the application processes corresponding to the application process shortcuts 3111˜3114. For example, in FIG. 3, when the event-detecting unit 12 detects the input signal of the user in the third control area 311 (such as the touch of the finger of the user), the application process executing unit 16 may execute the corresponding application process according to the application process shortcut (such as the application process shortcut 3111) located at the coordinate of the input signal on the touch-sensitive display unit. 11. These application processes may provide applications related to pictures, such as picture trimmings, resolution adjustments, or shading or brightness adjustments. The invention is not limited herein. For example, when a user touches the application process shortcut 3111, the application process executing unit 16 may activate the application process for adjusting the resolution of the picture, so that the user may enhance or reduce the resolution of the picture to be used as the wallpaper picture of the touch-sensitive display unit 11 with this application process.

It should be noted that the touch-sensitive display unit 11, the event-detecting unit 12, the picture-retrieving unit 13, the wallpaper picture-setting unit 14, the control region-defining unit 15 and the application process executing unit 16 according to the embodiment of the invention may be hardware devices constituted by logical circuit elements to execute the functions mentioned above. These units may also be firmware or software programs stored on the hard drive or the memory of the digital media controller 10, which can be loaded by the processor of the digital media controller 10 to perform the functions mentioned above.

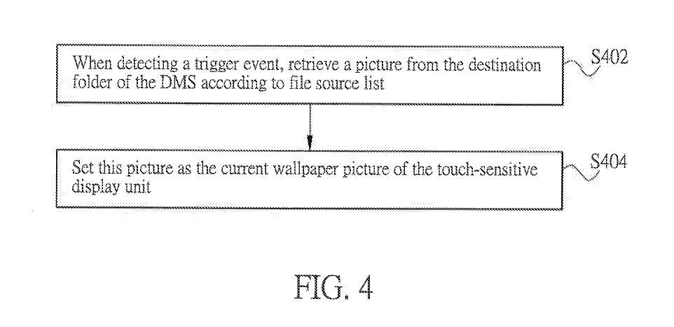

FIG. 4 is a schematic flowchart showing the method for setting a wallpaper picture according to an embodiment of the invention. Referring to FIG. 1 and FIG. 4, in step S402, when the event-detecting unit detects a trigger event (for example, when the user issues a instruction to switch the wallpaper picture), the picture-retrieving unit 13 retrieves a picture from the destination folder of the digital media server 20 according to tile source list. In step S404, the wallpaper picture-setting unit 14 sets this picture as the current wallpaper picture of the touch-sensitive display unit 11. In step S404, the wallpaper picture-setting unit 14 sets this picture as the current wallpaper picture of the touch-sensitive display unit 11, wherein the display size of this picture conforms to the desktop display rule of the touch-sensitive display unit 11. For example, the wallpaper picture-setting unit 14 may adjust the display size of this picture adaptively when being used as the wallpaper picture according to the desktop display rule of the touch-sensitive display unit 11 (for example, the resolution of the wallpaper picture or the display type of the wallpaper picture, the display type including displaying in full-screen, displaying in a set size, or displaying in the original size).

It should be noted that regarding the method above, sufficient teachings, suggestions and implementation explanations can be obtained from the embodiments mentioned above. Therefore they are omitted here for concise purpose.

To sum up, the method for setting a wallpaper picture and the digital media controller according to the embodiment of the invention can retrieve a picture automatically or according to user's needs, set the retrieved picture as the current wallpaper picture of the touch-sensitive display unit of the digital media controller immediately, and adjust the display size of the picture according to the desktop display rule of the touch-sensitive display unit of the digital media controller to display it at the desktop completely without distortion. Therefore, the convenience of setting the wallpaper picture of the electronic device is significantly enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for setting a wallpaper picture adapted for a digital media controller having a touch-sensitive display unit, the digital media controller having a file source list, the file source list providing a path of a destination folder of a digital media server, the method comprising:
retrieving a first picture from the destination folder of the digital media server according to the file source list when a trigger event is detected; and
using the first picture as a current wallpaper picture of the touch-sensitive display unit,
wherein a display size of the first picture conforms to a desktop display rule of the touch-sensitive display unit.

2. The method for setting a wallpaper picture according to claim 1, further comprising:
displaying a first operation interface; and
when a selecting operation corresponding to the first operation interface is detected, selecting the digital media server and the destination folder according to the selecting operation.

3. The method for setting a wallpaper picture according to claim 1, further comprising:
retrieving a second picture from the destination folder of the digital media server after a default time; and
setting the second picture as the current wallpaper picture of the touch-sensitive display unit,
wherein a display size of the second picture conforms to the desktop display rule of the touch-sensitive display unit.

4. The method for setting a wallpaper picture according to claim 3, further comprising:
setting the first picture as the current wallpaper picture of the touch-sensitive display unit when a first input signal is detected,
wherein the first input signal is triggered by touching a first control area of the touch-sensitive display unit.

5. The method for setting a wallpaper picture according to claim 4, further comprising:
retrieving a third picture from the destination folder of the digital media server according to the file source list when a second input signal is detected; and
setting the third picture as the current wallpaper picture of the touch-sensitive display unit,
wherein the second input signal is triggered by touching a second control area of the touch-sensitive display unit.

6. The method for setting a wallpaper picture according to claim 5, further comprising:
defining the first control area and the second control area of the touch-sensitive display unit.

7. The method for setting a wallpaper picture according to claim 4, further comprising:
re-retrieving the first picture from the destination folder of the digital media server according to the file source list.

8. The method for setting a wallpaper picture according to claim 4, further comprising:
executing an application process when a third input signal is detected,
wherein the third input signal is triggered by touching an application process shortcut on the touch-sensitive display unit.

9. A digital media controller, comprising:
a touch-sensitive display unit;
an event-detecting unit coupled with the touch-sensitive display unit for detecting a trigger event;
a picture-retrieving unit coupled with the event-detecting unit; and
a wallpaper picture-setting unit coupled with the touch-sensitive display unit, the event-detecting unit and the picture-retrieving unit,
wherein when the event-detecting unit detects a trigger event, the picture-retrieving unit retrieves a first picture from a destination folder of a digital media server according to a file source list,
wherein the wallpaper picture-setting unit sets the first picture as a current wallpaper picture of the touch-sensitive display unit,
wherein a display size of the first picture conforms to a desktop display rule of the touch-sensitive display unit.

10. The digital media controller according to claim 9, wherein the touch-sensitive display unit displays a first operation interface, and when the event-detecting unit detects a selecting operation corresponding to the first operation interface, the picture-retrieving unit selects the digital media server and the destination folder according to the selecting operation.

11. The digital media controller according to claim 9, wherein
the picture-retrieving unit retrieves a second picture from the destination folder of the digital media server after a default time,
the wallpaper picture-setting unit sets the second picture as the current wallpaper picture of the touch-sensitive display unit, and
a display size of the second picture conforms to the desktop display rule of the touch-sensitive display unit.

12. The digital media controller according to claim 11, wherein
when the event-detecting unit detects a first input signal, the wallpaper picture-setting unit sets the first picture as the current wallpaper picture of the touch-sensitive display unit, and
the first input signal is triggered by touching a first control area of the touch-sensitive display unit.

13. The digital media controller according to claim 12, wherein
when the event-detecting unit detects a second input signal, the picture-retrieving unit retrieves a third picture from the destination folder of the digital media server according to the file source list,
the wallpaper picture-setting unit sets the third picture as the current wallpaper picture of the touch-sensitive display unit, and
the second input signal is triggered by touching a second control area of the touch-sensitive display unit.

14. The digital media controller according to claim 13, further comprising:
a control region-defining unit coupled with the touch-sensitive display unit for defining the first control area and the second control area of the touch-sensitive display unit.

15. The digital media controller according to claim 12, wherein the picture-retrieving unit re-retrieves the first picture from the destination folder of the digital media server according to the file source list.

16. The digital media controller according to claim 12, further comprising:
an application process executing unit coupled with the event-detecting unit,
wherein when the event-detecting unit detects a third input signal, the application process executing unit executes an application process, and
wherein the third input signal is triggered by touching an application process shortcut on the touch-sensitive display unit.
